(19) United States
(12) Patent Application Publication
(10) Pub. No.: US 2012/0252046 A1
(43) Pub. Date: Oct. 4, 2012

(54) TRANSDERMAL SYSTEMS, DEVICES, AND METHODS FOR BIOLOGICAL ANALYSIS

(75) Inventors: Jiangfeng Fei, Sleepy Hollow, NY (US); Narasinha Parasnis, New Milford, CO (US); Swetha Chinnayelka, Derry, NH (US)

(73) Assignee: Bayer HealthCare LLC, Tarrytown, NY (US)

(21) Appl. No.: 13/515,715

(22) PCT Filed: Dec. 16, 2010
(86) PCT No.: PCT/US10/60786

§ 371 Date: Jun. 13, 2012

Related U.S. Application Data
(60) Provisional application No. 61/287,509, filed on Dec. 17, 2009.

(51) Int. Cl. G01N 27/00; G01N 21/00

(52) U.S. Cl. 435/14; 435/287.1; 435/288.7

(57) ABSTRACT

A transdermal test sensor includes a test chamber including a liquid, a reagent system in contact with the liquid, a housing containing the liquid, and a semipermeable membrane. The housing includes an opening, the semipermeable membrane is connected to the housing and covers the opening, and the housing and the semipermeable membrane enclose the liquid and the reagent system. The transdermal test sensor also includes an analyzer in communication with the liquid. When porated tissue is contacted with the semipermeable membrane and sufficient time is allowed for a fluid sample to traverse the porated tissue and for an analyte in the fluid sample to enter the liquid in the transdermal sensor through the semipermeable membrane, a change in at least one optical property or at least one electrical property of the liquid is detected. The change detected is then correlated with the analyte concentration in the fluid sample.

### REFERENCE TO RELATED APPLICATIONS

This application claims the benefit of U.S. Provisional Application No. 61/287,509 entitled “Transdermal Systems, Devices, and Methods For Biological Analysis” filed Dec. 17, 2009, which is incorporated by reference in its entirety.

### BACKGROUND

The quantitative determination of analytes in biological fluids is important in the diagnosis and maintenance of certain physiological abnormalities. For example, lactate, cholesterol, and bilirubin should be monitored in certain individuals. In particular, determining glucose concentrations in biological fluids is important to diabetic individuals who must regulate the glucose intake of their diets. The results of such tests may be used to determine what, if any, insulin or other medication should be administered.

Biological fluids may be obtained from an organism using invasive methods or non-invasive methods. In one example of an invasive method, a lancet is used to pierce a user's skin to draw a biological fluid sample, such as blood. This sample is then analyzed with a test sensor external to the skin to determine the concentration of analyte, such as glucose, in the sample. One disadvantage of this method is that the user's skin must be pierced each time an analyte concentration reading is desired. In another example of an invasive method, an implant may be placed under the user's skin, allowing multiple analyte concentration readings to be obtained without making a new puncture in the skin. In addition to patient discomfort from the implantation procedure and the healing process, immune system responses may adversely affect the usefulness of the implant. Thus, invasive methods may not be useful for some patients.

Conventional non-invasive methods for obtaining a biological fluid sample typically involve extracting a sample of interstitial fluid (ISF), which contains the analyte, to the surface of the skin for analysis. Transport of the ISF may be accomplished electrically through iontophoresis or by enlarging and/or creating pores through the stratum corneum of the skin. Since the sample moves from the epidermal layer of the skin, through the stratum corneum, and to the skin surface, such methods may be referred to as “transdermal.” Transdermal methods may be preferred to invasive methods as patient discomfort and immune system complications are substantially reduced. Transdermal methods also include techniques where the sample moves through tissues other than skin, such as mucosal tissues, to reach the test sensor.

Conventional transdermal analysis systems typically include a hydrogel containing an analyte selective reagent. ISF that reaches the surface of the skin or other tissue is transported into the hydrogel. The analyte contained in the ISF can then interact with the analyte selective reagent, and a measurable species responsive to this interaction is detected by an analyzer. The presence and/or amount of the measurable species can be used to determine the concentration of the analyte in the ISF.

Transdermal analysis systems based on hydrogels can have a number of disadvantages. Dehydration of the hydrogel can cause the diffusion properties of the hydrogel to change over time, leading to deterioration in the accuracy of the system. The cost of a hydrogel-based sensor can be prohibitively high, since high concentrations of expensive analyte selective reagent(s) are needed to generate sufficient signal. Other disadvantages include undesirably long response times due to the slow diffusion of analyte, reagent and/or detectable species within the crosslinked hydrogel material; poor mechanical properties of hydrogels; difficulties in reproducibly making, distributing and storing a hydrogel-based device; and the opportunity for the user to use the device incorrectly.

Accordingly, it would be desirable to have a transdermal sensor system that assists in addressing one or more of the above disadvantages.

### SUMMARY

The invention provides transdermal analysis systems, test sensors, methods, and kits for determining the presence and/or concentration of at least one analyte in a fluid sample. The concentration of the at least one analyte may be determined in ISF that has passed through a tissue to reach the aqueous material of the test sensor.

A transdermal test sensor includes a test chamber and an analyzer. The test chamber includes a liquid, a reagent system in contact with the liquid, a housing containing the liquid, and a semipermeable membrane. The housing includes an opening, and the semipermeable membrane is connected to the housing and covers the opening. The housing and the semipermeable membrane enclose the liquid and the reagent system. The semipermeable membrane includes a hydrophilic surface and a maximum pore diameter of 10 to 50 nm. The analyzer is in communication with the liquid.

A transdermal analysis system includes a transdermal test sensor including a test chamber and an analyzer in communication with the test chamber, and a measurement device in communication with the analyzer.

A transdermal analysis system includes means for contacting porated tissue with a semipermeable membrane of a transdermal sensor, means for allowing a fluid sample to traverse the porated tissue and enter a liquid in the transdermal sensor through the semipermeable membrane, means for detecting a change in at least one optical property or at least one electrical property of the liquid, and means for correlating the change in the at least one optical property or at least one electrical property of the liquid with the concentration of the at least one analyte in the fluid sample.

In a method for determining a concentration of at least one analyte in a fluid, porated tissue is contacted with a semipermeable membrane of a transdermal sensor. Sufficient time is allowed for a fluid sample to traverse the porated tissue and for an analyte in the fluid sample to enter a liquid in the transdermal sensor through the semipermeable membrane. A change in at least one optical property or at least one electrical property of the liquid is detected. The change in the at least one optical property or at least one electrical property of the liquid is correlated with the concentration of the at least one analyte in the fluid sample.

The scope of the present invention is defined solely by the appended claims and is not affected by the statements within this summary.

### BRIEF DESCRIPTION OF THE DRAWINGS

The invention can be better understood with reference to the following drawings and description. The components in the figures are not necessarily to scale and are not intended to accurately represent molecules or their interactions, emphasis instead being placed upon illustrating the principles of the invention.

FIG. 1 represents a transdermal test sensor.

FIG. 2 depicts a graph of water content over time for two different test chambers.

FIG. 3 plots electrical current response as a function of glucose concentration for simulated test chambers having different semipermeable membranes.

FIG. 4 plots electric current against glucose bioequivalent concentration for test sensors having different test chambers.

FIG. 5A plots the response time for an increase or a decrease in glucose concentration in a sample for test sensors having different test chambers.

FIG. 5B plots the time for the sensors of FIG. 5A to produce 90% of their maximum response.

FIG. 6 represents a transdermal test sensor configured for electrochemical analysis.

FIG. 7 represents a transdermal test sensor configured for optical analysis.

FIG. 8 depicts a method of determining the presence and/or concentration of an analyte in a fluid sample with a transdermal test sensor.

FIG. 9 depicts a schematic representation of a transdermal analysis system that determines an analyte concentration in a sample.

### DETAILED DESCRIPTION

A transdermal analysis system uses a transdermal test sensor and a measurement device. The test sensor includes a test chamber and an analyzer. The test chamber includes a liquid, a reagent system, a housing and a semipermeable membrane. The housing includes an opening, and the semipermeable membrane is connected to the housing and covers the opening. The housing and the semipermeable membrane enclose the liquid and the reagent system. The semipermeable membrane has a hydrophilic surface and has a maximum pore diameter of 10 nanometers (nm) to 50 nm. The semipermeable membrane may be a track-etched membrane. The analyzer is in communication with the liquid.

When a sample of biological fluid containing an analyte contacts the semipermeable membrane, the analyte can traverse the semipermeable membrane to enter the liquid in the test chamber. The semipermeable membrane allows the analyte to enter the test chamber, but substantially prevents dehydration of the liquid in the test chamber. The reagent system interacts with the analyte and produces a measurable species, which is detected by the analyzer. The measurement device may then correlate the presence and/or amount of the measurable species with the analyte concentration of the sample.

FIG. 1 represents a transdermal test sensor 100 including a test chamber 110 that includes a housing 120, a semipermeable membrane 130, a liquid 140, and a reagent system 150 in contact with the liquid. The transdermal test sensor 100 further includes an analyzer 190 in communication with the liquid 140. The housing 120 includes an opening, and the semipermeable membrane 130 is connected to the housing and covers the opening. The housing 120 and the semipermeable membrane 130 in combination enclose the liquid 140.

The test sensor 100 may be placed on any surface of a body where sufficient biological fluid may be obtained for analysis, such as on the volar forearm between the wrist and the elbow. While “skin” is typically used to describe the tissue with which the test sensor 100 is in fluid communication, the sensor 100 may be in fluid communication with any tissue type suitable for passing an analyte for analysis, such as mucosal, muscle, and organ.

The test sensor 100 may be used to determine the concentration of one or more analytes in a biological fluid, such as ISF, residing on the other side of the tissue from the test sensor 100. Examples of analytes include, but are not limited to, glucose, lactate, glutamate, cholesterol, calcium, urea, triglycerides, high density lipoprotein (HDL), low density lipoprotein (LDL), bilirubin, fructosamine, and hematocrit. For example, the test sensor 100 may be used to determine the glucose concentration in ISF drawn through the forearm skin. In addition to glucose, the test sensor 100 may optionally determine the concentration of another analyte. In another example, the test sensor 100 may be used to determine the concentration of one or two non-glucose analytes in the sample. ISF is the preferred sample, although other biological fluids also may be used.

The test sensor 100 may be used to determine the concentration of one or more analytes while residing on the surface of the body for an extended time period. The extended time period may extend up to one day. Preferably the extended time period extends up to 2 days, up to 3 days, up to 5 days, up to one week, and preferably may extend longer than a week.

During this extended time period the reagent system 150 of the test sensor 100 may be optically or electrochemically read continuously or intermittently. Preferably, the reagent system 150 is intermittently read at least once every 10 to 20 minutes, at least once every 6 to 10 minutes, or at least once every 4 to 6 minutes. Shorter time periods, such as at least once every 4 minutes or less, at least once every 2 to 4 minutes, and at least once every 1 to 2 minutes also may be used. Longer time periods, such as at least once every hour, at least once every 12 hours, at least once a day, at least once a week, at least once every 2 weeks, and at least once every month also may be used.

The test sensor 100 may be used to determine the concentration of one or more analytes when desired by a user. The test sensor 100 may be placed on the surface of the body, the reagent system 150 may be read, and then the test sensor may be removed from the surface of the body. In this arrangement, the test sensor 100 may be used only once, or it may be used more than once. For example, after the test sensor 100 has been used to determine the concentration of one or more analytes, it may be removed from the surface of the body and stored for future use, such as by sealing it and/or placing the semipermeable membrane of the sensor in contact with a solution. The same test sensor may then be used to determine the concentration of one or more analytes again at a later time.

The housing 120 and the semipermeable membrane 130 provide the physical boundaries of the test chamber 110. The housing 120 and the semipermeable membrane 130 enclose the liquid 140, and are configured to provide communication between the liquid 140 and the analyzer 190. The internal volume of the test chamber 110 may be from 1 microliters to 50 milliliters (mL). Preferably, the internal volume is from 100 microliters to 10 mL, and more preferably is from 500 microliters to 2 mL. The test chamber 110 may be rigid, it may be flexible, or it may include both rigid and flexible regions. Preferably, the test chamber 110 includes materials that are both tough and flexible, to help ensure that the liquid 140 remains isolated during normal processing, storage, and use of the test sensor 100.

The housing 120 may include any material that is substantially impermeable to the liquid 140. Examples of materials for the housing 120 include polymers, metals and ceramics. Preferably, the housing 120 includes a flexible material. More preferably, the housing 120 includes a polymer that is flexible at temperatures from −50° C. to 100° C. A polymer that is flexible at a temperature has a flexural strength of at most 50 megaPascals (MPa) at that temperature. Preferably, the housing 120 includes a polymer having a flexural strength at temperatures from −50° C. to 100° C. of at most 40 MPa, more preferably of at most 30 MPa, and more preferably of at most 20 MPa.

The housing 120 may include a single material, or it may include more than one type of material. For example, the housing may include a laminate of two or more materials. In another example, the housing may include two or more regions, each region including a different material or combination of materials. In one example of a housing that includes two or more regions, one of the regions of the housing may be more flexible than the other region. Preferably at least a portion of the housing is flexible enough to conform to the body of a patient when the test sensor 100 is placed on the patient. In another example of a housing that includes two or more regions, one of the regions of the housing may be transparent to electromagnetic radiation having a wavelength of from 300 nm to 1,400 nm, and the other region may be translucent or opaque to electromagnetic radiation having a wavelength of from 300 nm to 1,400 nm. The housing may also include a material that connects the semipermeable membrane 130 to the rest of the housing material.

The housing 120 may be configured to provide communication between the liquid 140 and the analyzer 190. For example, the housing 120 may include at least one opening through which a component of the analyzer 190 can be in physical contact with the liquid 140. In another example, the housing 120 may include a region that provides optical or electrochemical communication between the liquid 140 and the analyzer 190.

The semipermeable membrane 130 may include any material that allows the analyte to enter the liquid 140, but that substantially prevents loss of the liquid from the test chamber 110. Examples of semipermeable membrane materials include cellulose, cellulose ester such as ethyl cellulose, polypropylene, polyester, polycarbonate, polyamide, polysulfone, poly(vinylidene fluoride), polyimide and polyetherimide. The semipermeable membrane 130 also may include an adhesive, such as an adhesive for attaching the semipermeable membrane 130 to the tissue of a patient.

Preferably, the semipermeable membrane 130 has a hydrophilic surface. A hydrophilic surface is defined as a surface having a water contact angle less than 45°. The water contact angle for a membrane surface is measured by depositing a droplet of water on the surface and then measuring the contact angle between the advancing liquid front and the surface plane. A hydrophilic membrane surface may help to reduce or eliminate undesired interactions between the membrane and various components of the fluid sample. For example, biological fluid samples may include substances that tend to adsorb onto hydrophobic surfaces. Thus, a hydrophilic membrane surface can prevent these substances from adsorbing and interfering with the detection of the analyte.

In one example, the semipermeable membrane 130 may include a semipermeable substrate and a hydrophilic layer on at least a portion of the semipermeable substrate. In a specific example, the semipermeable membrane 130 may include a porous polycarbonate substrate and a surface layer of poly(vinyl pyrrolidone) (PVP) on the substrate.

Preferably, the pores of semipermeable membrane 130 are large enough to permit an analyte to pass from the fluid sample to the liquid 140, yet are small enough to minimize the loss of the liquid 140 and/or the reagent system 150 from the test chamber 110. The ideal range of the pore size may depend on the identity of the liquid 140, the identity and location of the reagent system 150, and the components of the fluid sample to be analyzed. Preferably, if the liquid 140 is an aqueous liquid, the semipermeable membrane 130 has a maximum pore diameter less than 100 nm. An aqueous liquid is a liquid that includes at least 50% by volume water. The maximum pore diameter of a semipermeable membrane is the largest diameter of the pores of the membrane, as measured by scanning electron microscopy (SEM).

The semipermeable membrane 130 preferably prevents loss of the liquid from the test chamber 110. For conventional hydrogel-based test sensors, dehydration of water from the hydrogel can be a significant concern, since the diffusion rate of glucose can be affected by its concentration. A test sensor including the semipermeable membrane 130 and liquid 140 in which the liquid 140 is an aqueous liquid preferably retains more water than does a comparable test sensor that instead includes a hydrogel. For example, the amount of water in the liquid 140 may decrease by a first percentage when the semipermeable membrane 130 is in contact with porated tissue for 12 hours. For a comparable sensor, in which the aqueous liquid and semipermeable membrane are replaced with a hydrogel containing water, the amount of water in the hydrogel may decrease by a second percentage when the hydrogel is in contact with porated tissue for 12 hours. Preferably the second percentage is 5 times greater than the first percentage. More preferably the second percentage is 10 times greater than the first percentage.

For a semipermeable membrane having a hydrophilic surface and a maximum pore diameter less than 100 nm, water typically will not flow through the membrane. Applying a water pressure of 10 psid (0.7 kg/cm²) to such a membrane preferably provides for an initial water flow rate of less than 2.5 mL/min/cm². Water and other small molecules, such as small-molecule analytes, may still traverse the semipermeable membrane 130, but the liquid 140 in the test chamber 110 will not substantially leave the test chamber.

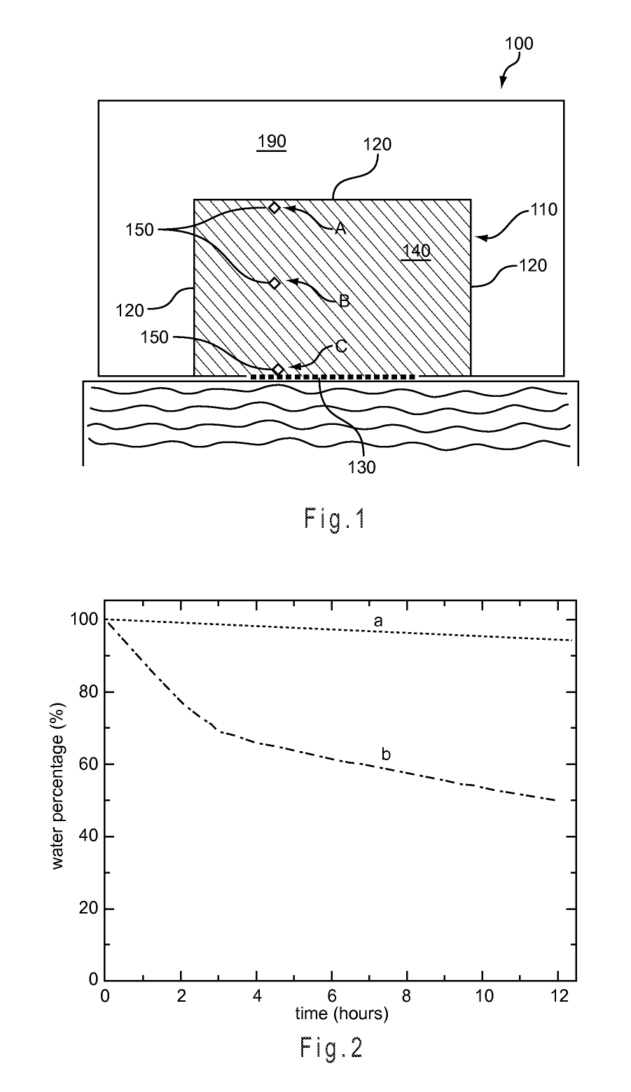

FIG. 2 plots water content over time for a test chamber including a housing, a semipermeable membrane and an aqueous liquid enclosed by the housing and the semipermeable membrane (a), and for a similar test chamber in which the aqueous liquid and semipermeable membrane were replaced with a hydrogel (b). Within the first 12 hours, the test chamber including the semipermeable membrane lost approximately 5% of its water. For the first 5 days of the test, the dehydration rate of this test chamber was approximately 10% per day (not shown on graph). In contrast, the test chamber that included the hydrogel lost approximately 50% of its water within the first 12 hours. Thus, the percentage of water lost over 12 hours from the test chamber containing the hydrogel was 10 times greater than the percentage of water lost over 12 hours from the test chamber containing the aqueous liquid and the semipermeable membrane.

In the experiments for FIG. 2, the test chambers were cylindrical wells having a diameter of 12.7 mm and a height of 1.5 mm. The aqueous liquid in the test chamber was a buffer solution (10 mM phosphate buffered saline, pH 7.4), and the semipermeable membrane was a track etched polycarbonate membrane having a PVP surface layer and a 50 nm maximum pore diameter (Millipore). The volume of the liquid was 1 mL. In contrast, the hydrogel in the other test chamber was a poly(vinyl acetate)/poly(vinyl pyrrolidone) (PVA/PVP) gel swelled with the identical buffer solution. The mass of water in the hydrogel was 0.2355 grams. Each test chamber was placed separately between two glass slides, one of which had a coating of a hydrophobic polymer to simulate skin tissue. The test chamber was positioned so that either the semipermeable membrane (a) or the hydrogel (b) was in contact with the hydrophobic polymer on the glass slide. The mass of the chamber was measured every 24 hours, and any decrease in the mass was taken as the loss of water due to dehydration.

The performance of the test sensor 100 can be affected by the characteristics of the semipermeable membrane 130. A test sensor including a semipermeable membrane having a larger maximum pore diameter may have an increased sensitivity to the analyte and/or may have a faster response time than a comparable sensor having a semipermeable membrane with a smaller maximum pore diameter. Sensitivity is defined as the change in sensor response as a function of analyte concentration. Response time is defined as the time between the start of an analysis and the first measurable response of the sensor. If the maximum pore diameter of the semipermeable membrane 130 is too large, however, components of the liquid 140 and/or reagent system 150 may be lost from the test chamber 110 through the semipermeable membrane. Preferably, the maximum pore diameter of the semipermeable membrane 130 is from 10 to 50 nm. More preferably, the maximum pore diameter of the semipermeable membrane 130 is from 30 to 50 nm.

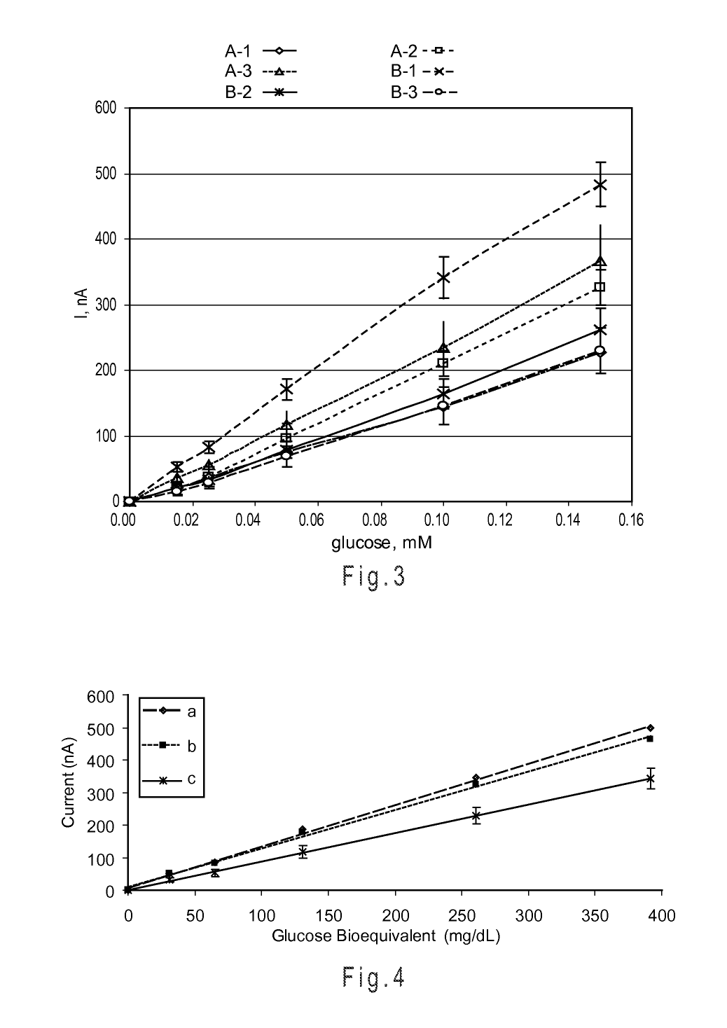

FIG. 3 plots electrical current response as a function of glucose concentration for simulated test chambers having different semipermeable membranes. One set of membranes, labeled “A”, had a nominal thickness of 6 micrometers, and had maximum pore diameters of 10 nm (A-1), 30 nm (A-2) and 50 nm (A-3). For the A-type membranes, the sensitivity of the simulated test chamber increased as the maximum pore diameter increased. However, although the membrane with the 50 nm maximum pore diameter had the highest sensitivity, its sensitivity decreased over time. One possible explanation for this loss of sensitivity for the membrane having the 50 nm maximum pore diameter is that the glucose oxidase enzyme in the test chamber leached through the membrane over time, since the molecular weight of the enzyme (160,000 Daltons) was close to the molecular weight cutoff of this membrane (100,000 Daltons).

In the experiments for FIG. 3, two electrodes were placed in contact with a buffer (200 microliters of 10 mM PBS buffer, pH=7.4) in separate chambers, and the semipermeable membrane was placed over the two chambers to seal the buffer over each electrode. The chambers were cylindrical wells having a height of diameter of 12.7 mm and a height of 1.5 mm. For one of the electrodes, the buffer included 0.2 mg (1 mg/mL) glucose oxidase enzyme, while the buffer for the other electrode did not include an enzyme for glucose. Two channels were placed on the membrane, with a first channel over the first electrode and buffer, and the second channel over the second electrode and buffer. An aqueous sample was passed through the channels at a flow rate of 0.5 mL/min. For the first 2 hours, the aqueous sample was the 10 mM PBS buffer (pH=7.4), after which controlled concentrations of glucose were present in the sample. The glucose concentrations were 0.015 mM, 0.025 mM, 0.05 mM, 0.1 mM and 0.15 mM, and each concentration was maintained for 30 minutes. A voltage difference of 0.6 V (vs. Ag/AgCl) was applied between the two electrodes with a CH Instrument Model 1000A Series multi-potentiostat. The electrical current was measured as the response of the simulated test chamber to the glucose.

Referring still to FIG. 3, the other type of membrane, labeled “B”, had a nominal thickness of 7 micrometers, and had a maximum pore diameter of 50 nm. For the B-type membrane, the enzyme of the simulated test chamber was either free in the liquid (B-1), immobilized on the electrode (B-2) or immobilized on the membrane (B-3). Both of the chambers that included immobilized enzyme had sensitivities that were half of that for the chamber including the free enzyme, even though the amount of immobilized enzyme was three times that of the free enzyme. One possible explanation for this difference in performance is that the immobilized enzymes were less available to the glucose entering the chamber than were the free enzymes, resulting in a lower sensitivity to the glucose. However, the sensitivity of the chamber having free enzyme decreased over time, whereas the chambers having immobilized enzyme did not show a decrease in sensitivity over time. One possible explanation for this difference in performance is that the free enzymes could leach through the 50 nm maximum pore diameter membrane over time, but the immobilized enzymes were prevented from leaching due to their immobilization.

The experiments for the B-type membrane were identical to those for the A-type membrane, except for the glucose oxidase enzyme. For the B-1 membrane, the buffer on one electrode included 0.2 mg (1 mg/mL) glucose oxidase enzyme, while the buffer for the other electrode did not include an enzyme for glucose. For the B-2 membrane, neither buffer included an enzyme for glucose, but 0.6 mg of glucose oxidase was immobilized on one electrode. For the B-3 membrane, neither buffer included an enzyme for glucose, but 0.6 mg of glucose oxidase was immobilized on the membrane above one electrode.

Preferably, the diameters of the pores of the semipermeable membrane 130 are from 80% to 100% of the maximum pore diameter. In contrast, less preferred semipermeable membranes have a known maximum pore diameter, but may include pores having diameters less than 80% of the maximum pore diameter. A membrane that has a more narrow range of pore diameters can provide a separation of small molecules from large molecules that is more precise than that provided by a membrane having a wider range of pore diameters.

An example of a class of semipermeable membranes that has a narrow range of pore diameters is the class of track-etched membranes. Track-etched membranes are produced by irradiating a polymer film with charged particles, such as particles from a cyclotron or a nuclear reactor. The charged particles pass through the film in substantially straight lines, and the film is at least partially degraded along these lines. The film is then exposed to an etching treatment, which dissolves away the at least partially degraded portions of the film to form a porous membrane. The resulting membrane has pores that are substantially cylindrical and that are substantially uniform in their dimensions. Track-etched membranes are described, for example, in Baker, R. W., “Membrane Technology” Encyclopedia of Polymer Science and Technology, John Wiley & Sons, 184-249, 2001; and in Hanot, H. et al, “Expanding the use of track-etched membranes” IVD Technology, p. 41ff, November 2002.

The liquid 140 is enclosed by the housing 120 and the semipermeable membrane 130. The liquid 140 provides a medium in which the analyte and the reagent system 150 can interact to produce a measurable species that is measured by the analyzer 190. Preferably the liquid 140 is an aqueous liquid, and more preferably is an aqueous buffer. The viscosity of the liquid may be from 0.01 to 1 poise.

A test sensor including the liquid 140 and the semipermeable membrane 130 preferably provides for an interaction between the analyte and the reagent system 150 that is more sensitive and/or more rapid than that provided by a comparable test sensor that instead includes a hydrogel. One possible reason for an improvement in sensitivity and/or rate of interaction is that the analyte can diffuse to the reagent system more quickly in a liquid than in a hydrogel.

In one example, when the test sensor 100 is used to determine the concentration of glucose in a fluid, the sensor 100 has a first glucose sensitivity. When a comparable sensor, in which the liquid and semipermeable membrane are replaced with a hydrogel, is used to determine the concentration of glucose in the fluid, the comparable sensor has a second glucose sensitivity. Preferably the first glucose sensitivity is at least 20% greater than the second glucose sensitivity. Preferably the first glucose sensitivity is at least 30% greater than the second glucose sensitivity.

FIG. 4 plots electric current (nanoamps) against glucose bioequivalent concentration (milligrams per deciliter) for test sensors including a test chamber having a housing, a semipermeable membrane, an aqueous liquid enclosed by the housing and the semipermeable membrane and a reagent system in contact with the liquid (a, b), and for similar test chambers in which the aqueous liquid and semipermeable membrane were replaced with a hydrogel (c, average of 9 analyses). The test sensors including a semipermeable membrane and a liquid had glucose sensitivities of 21.3 and 23.1 nanoamps per millimolar (nA/mM), whereas the test sensors based on the hydrogel had an average glucose sensitivity of 17.4 nA/mM. Thus, the test sensors including a semipermeable membrane and a liquid had glucose sensitivities that were 22% and 32% greater than the average glucose sensitivity of the test sensors based on the hydrogel.

In another example, when the test sensor 100 is used to determine the concentration of glucose in a fluid, the sensor 100 has a first response time and has a first time for producing 90% of its maximum response. When a comparable sensor, in which the aqueous liquid and semipermeable membrane are replaced with a hydrogel, is used to determine the concentration of glucose in the fluid, the comparable sensor has a second response time and has a second time for producing 90% of its maximum response. Preferably the first response time is at least 50% shorter than the second response time. Preferably the first time for producing 90% of the maximum response is at least 2 minutes shorter than the second time for producing 90% of the maximum response.

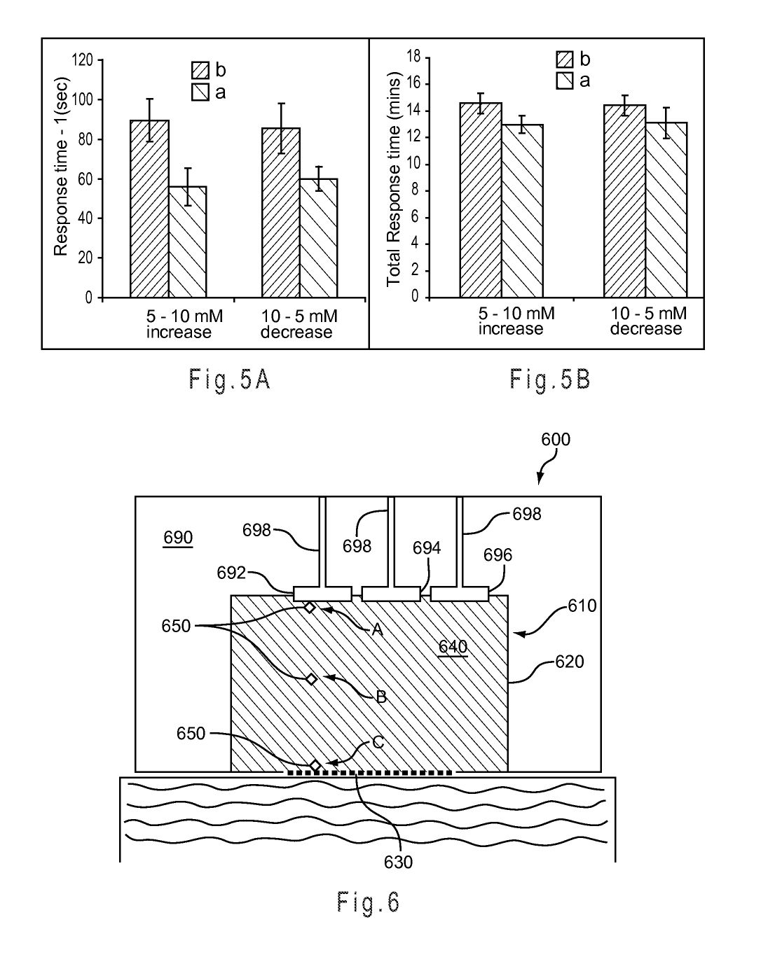

FIG. 5A plots the response time for an increase or a decrease in glucose concentration in a sample for a test sensor including a test chamber having a housing, a semipermeable membrane, an aqueous liquid enclosed by the housing and the semipermeable membrane and a reagent system in contact with the liquid (a), and for a similar test chamber in which the aqueous liquid and semipermeable membrane were replaced with a hydrogel (b). The response time of the test sensor including the semipermeable membrane was approximately 50% shorter than the response time of the test sensor including the hydrogel.

FIG. 5B plots the time for the sensors of FIG. 5A to produce 90% of their maximum response. The time for the test sensor including the semipermeable membrane to produce 90% of its maximum response was approximately 2 minutes shorter than the time for the test sensor including the hydrogel to produce 90% of its maximum response.

The reagent system 150 interacts with the desired analyte to produce a measurable species, while the analyzer 190 detects and/or quantifies the measurable species. The measurable species produced in response to the interaction of the reagent system 150 and the analyte may be measured by a variety of analytical techniques, such as electrochemical analysis and optical analysis.

The components of the reagent system 150 independently may be at a variety of locations within the test chamber 110. For example, one or more components of the reagent system 150 independently may be attached to the interior of the housing 120, as represented by position A in FIG. 1. In another example, one or more components of the reagent system 150 independently may not be attached to the test chamber 110, but rather may be in the liquid 140, as represented by position B in FIG. 1. In yet another example, one or more components of the reagent system 150 independently may be attached to the semipermeable membrane 130, as represented by position C in FIG. 1. One or more components of the reagent system 150 also may reside external to the test chamber 110 when the test sensor 100 is formed and/or used. For example, the test sensor 100 may be equipped with a port allowing for additional reagent component(s) to be added before and/or during use.

One or more components of the reagent system 150 preferably are physically or chemically attached to the interior of the test chamber 110. Reagent system components that are attached to the interior of the test chamber are substantially immobilized, and thus are prevented from diffusing out of the liquid 140 through the semipermeable membrane 130. One or more components of the reagent system 150 may be physically or chemically attached to the semipermeable membrane 130. One or more components of the reagent system 150 may be physically or chemically attached to the portion of the housing 120 at or near the region at which the analyzer 190 and the liquid 140 are in communication. One or more components of the reagent system 150 may be in contact with the analyzer.

The reagent system 150 typically is an expensive part of the test sensor 100, relative to the other parts of the sensor. Sensor 100 can provide a rapid and accurate analysis of a fluid sample using a much smaller amount of the reagent system 150 than that required by conventional hydrogel-based transdermal sensors. Preferably, the mass of the reagent system in sensor 100 needed to provide a particular response to an analyte concentration in a sample is at least ten times less than the mass of the same reagent system needed to provide the same response in a sensor system that is identical except for the substitution of the liquid 140 and the semipermeable membrane 130 with a hydrogel containing the reagent system. More preferably, the mass of the reagent system in sensor 100 needed to provide a particular response to an analyte concentration in a sample is at least one hundred times less, or at least five hundred times less, than the mass of the same reagent system needed to provide the same response in a sensor system that is identical except for the substitution of the liquid 140 and the semipermeable membrane 130 with a hydrogel containing the reagent system.

In one example, when the test sensor 100 that includes a first amount of an enzyme is used to determine the concentration of glucose in a fluid, the sensor 100 has a first glucose sensitivity, a first response time, and a first time for producing 90% of a maximum response. When a comparable sensor, in which the liquid and semipermeable membrane are replaced with a hydrogel containing a second amount of an enzyme, is used to determine the concentration of glucose in the fluid, the comparable sensor has a second glucose sensitivity, a second response time and a second time for producing 90% of a maximum response. When the second glucose sensitivity is less than the first glucose sensitivity, the second response time is longer than the first response time, and/or the second time for producing 90% of a maximum response is longer than the first time for producing 90% of a maximum response, the first amount of enzyme preferably is at least 10 times less than the second amount of the enzyme. More preferably, when the second glucose sensitivity is less than the first glucose sensitivity, the second response time is longer than the first response time, and/or the second time for producing 90% of a maximum response is longer than the first time for producing 90% of a maximum response, the first amount of enzyme is at least 100 times less than the second amount of the enzyme, or is at least 500 times less than the second amount of the enzyme.

For example, in the test sensors including a semipermeable membrane and an aqueous liquid that were used to produce results plotted in FIGS. 4, 5A and 5B, the amount of glucose oxidase (GOx) enzyme in the liquid was 0.2 mg. In contrast, in the test sensors including a hydrogel that were used to produce results plotted in FIGS. 4, 5A and 5B, the amount of GOx in the hydrogel was 110 mg. Thus, the test sensors including a semipermeable membrane and a liquid provided improved glucose measurements, even though the sensors contained approximately 500 times less GOx enzyme than the comparable hydrogel sensors.

The reagent system 150 includes an analyte specific reagent and optionally includes a detection substance. An analyte specific reagent is a substance that interacts with an analyte to transform the reagent and/or the analyte. The term “to transform” means to convert a substance into a product (transformed substance), where the product has a chemical structure different from that of the substance. The transformed reagent or analyte may be a measurable species that can be detected and/or quantified by the analyzer 190. The transformed reagent or analyte may not be a measurable species, in which case a detection substance in the reagent system 150 may be transformed into a measurable species in response to the interaction of the analyte specific reagent with the analyte.

By changing the analyte specific reagent of the reagent system 150, the concentration and/or presence of different analytes, such as cholesterol, ketones, glutamate, lactate, and glucose, may be determined. For fluorescence resonance energy transfer (FRET) and antibody/analog based detection systems, such as for cholesterol, an increase in cholesterol concentration should be reflected in a decrease in FRET from the antibody/analog system, and thus an anti-cholesterol antibody may be paired with an analog, such as 22-(N-(7-nitrobenz-2-oxa-1,3-diazol-4-yl)amino)-23,24-bisnor-5-cholen-3β-ol,fluoresterol, NBD-cholesterol, and the like. For glutamate, an anti-glutamate antibody may be paired with an analog, such as glutamate dimethyl ester, alpha-aminomethylglutarate, and the like. For lactate, an anti-lactate antibody may be paired with an analog, such as benzoylformate and the like. Analogs for these and other analytes also may be made by designing appropriate molecular imprinted polymers.

For glucose, possible analyte specific reagents include glucose binding protein, boronic acids with a high affinity for glucose, concanavalin A (Con A), and apoenzymes. In the presence of glucose, these binding moieties undergo a conformational or electronic change that may be detected with the appropriate optically-active dye or dyes. In competitive binding reactions, K_{d} can be adjusted by varying the receptor to ligand concentration ratio, and thus the sensitivity can be tailored in the range of analyte concentrations expected to enter the liquid 140.

Preferred analyte specific reagents for inclusion in the reagent system 150 include enzymes that are substantially specific to an analyte or analyte by-product, and/or analyte binding moieties that substantially bind with an analyte or analyte by-product. For example, an enzyme for use as an analyte specific reagent of the reagent system 150 for lactate analysis includes lactate oxidase, which produces lactic acid in the presence of lactate. In this example, the change in the pH of the sample due to the oxidation of lactic acid by the enzyme may be measured. In another example, enzymes for use as analyte specific reagents of the reagent system 150 for glucose analysis include glucose oxidase (GOx), glucose dehydrogenase (GDH), hexokinase, glucokinase, and the like. In the presence of glucose, these enzymes release reaction by-products that may be detected with the appropriate detection substances.

In enzymatic reactions, the dissociation constant (K_{d}) is fixed; therefore, enzymes for use in the reagent system 150 are preferably selected in response to the required physiological range of the analyte expected to enter the liquid 140. For example, when the analyte is glucose contained in ISF that travels through porated tissue to reach the semipermeable membrane 130, the physiological concentration of glucose in the ISF sample is preferably from 0 to 600 micromolar before the ISF sample reaches the semipermeable membrane 130. More preferably, the concentration of glucose in the ISF sample reaching the semipermeable membrane 130 is from 0 to 300 micromolar. At present, glucose concentrations of from 0 to 200 micromolar are most preferred in the ISF sample reaching the semipermeable membrane 130.

The optional detection substance is responsive to an interaction between the analyte and the analyte specific reagent. A detection substance is transformed into a measurable species in response to this interaction, and this measurable species can be detected and/or quantified by the analyzer 190. The detection substance of the reagent system 150 may be selected based on the type of analyzer 190 present in the test sensor 100. In one example, an electrochemically-active detection substance is used with an electrochemical analyzer. An electrochemically-active detection substance is a substance that undergoes an oxidation-reduction (redox) reaction in response to the interaction of the analyte and the analyte specific reagent. In another example, an optically-active detection substance is used with an optical analyzer. An optically-active detection substance is a substance having an optical property that changes in response to the interaction of the analyte and the analyte specific reagent.

A measurable species formed in response to the interaction of the reagent system 150 with an analyte may be measured electrochemically, such as by detection of the measurable species with an electrode in communication with the liquid. The detection may be accomplished through any known electrochemical technique compatible with the sample, the test sensor 100, and the reagent system 150. The measurable species may be the transformed analyte specific reagent, the transformed analyte, or the transformed electrochemically-active detection substance.

Electrochemically-active detection substances in the reagent system 150 may include a mediator that can communicate to the conductor the results of the interaction between the analyte and the analyte specific reagent. Mediators may be oxidized or reduced and may transfer one or more electrons. A mediator is a substance in an electrochemical analysis and is not the analyte of interest, but provides for the indirect measurement of the analyte. In a simple system, the mediator undergoes a redox reaction in response to the oxidation or reduction of the analyte. The oxidized or reduced mediator then undergoes the opposite reaction at the working electrode of the test sensor and may be regenerated to its original oxidation number. Thus, the mediator may facilitate the transfer of electrons from the analyte to the working electrode.

Mediators may be separated into two groups based on their electrochemical activity. One electron transfer mediators are chemical moieties capable of taking on one additional electron during the conditions of the electrochemical reaction. Multi-electron transfer mediators are chemical moieties capable of taking on more than one electron during the conditions of the reaction. One electron transfer mediators can transfer one electron from the enzyme to the working electrode, while a multi-electron transfer mediator can transfer two or more electrons. For example, a two electron transfer mediator can transfer two electrons from the enzyme to the working electrode.

Examples of one electron transfer mediators include compounds, such as 1,1′-dimethyl ferrocene, ferrocyanide and ferricyanide, and ruthenium(III) and ruthenium(II) hexaamine. Two electron mediators include the organic quinones and hydroquinones, such as phenanthroline quinone; phenothiazine and phenoxazine derivatives; 3-(phenylamino)-3H-phenoxazines; phenothiazines; and 7-hydroxy-9,9-dimethyl-9H-acridin-2-one and its derivatives. Examples of additional two electron mediators include the electro-active organic molecules described in U.S. Pat. Nos. 5,393,615; 5,498,542; and 5,520,786, which are incorporated herein by reference, for example.

Preferred two electron transfer mediators include 3-phenylimino-3H-phenothiazines (PIPT) and 3-phenylimino-3H-phenoxazines (PIPO). More preferred two electron mediators include the carboxylic acid or salt, such as ammonium salts, of phenothiazine derivatives. At present, especially preferred two electron mediators include (E)-2-(3H-phenothiazine-3-ylideneamino)benzene-1,4-disulfonic acid (Structure I), (E)-5-(3H-phenothiazine-3-ylideneamino)isophthalic acid (Structure II), ammonium (E)-3-(3H-phenothiazine-3-ylideneamino)-5-carboxybenzoate (Structure III), and combinations thereof. The structural formulas of these mediators are presented below. While only the di-acid form of the Structure I mediator is shown, mono- and di-alkali metal salts of the acid are included. At present, the sodium salt of the acid is preferred for the Structure I mediator. Alkali-metal salts of the Structure II mediator also may be used.

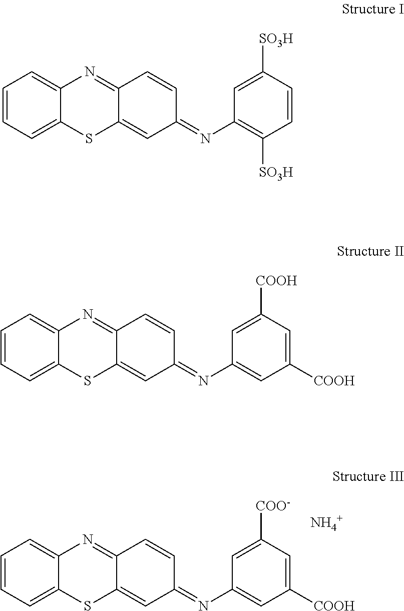

In another respect, preferred two electron mediators have a redox potential that is at least 100 mV lower, more preferably at least 150 mV lower, than ferricyanide.

The reagent system 150 for an electrochemical analysis also may include a charge transfer system. A charge transfer system is any one or a combination of electrochemically active species that may transfer one or more electrons from or to a counter electrode. For example, if the working electrode of a system transfers electrons to a counter electrode through the measurement device, the charge transfer system of the counter electrode accepts electrons from the counter electrode to allow the measurement of current flow through the system. By accepting electrons at a specific potential or potential range, the charge transfer system influences the potential at which the working electrode may transfer electrons for measurement. The charge transfer system may or may not include the mediator present at the working electrode; but if it does, at least a portion of the mediator at the counter electrode preferably has an oxidation state different than the mediator at the working electrode.

A measurable species formed in response to the interaction of the reagent system 150 with an analyte may be measured optically, such as by detection of the measurable species through its alteration of at least one light beam that passes through, or impinges on, at least a portion of the liquid. The detection may be accomplished through any known spectroscopic technique compatible with the sample, the test sensor 100, and the reagent system 150. The measurable species may be the transformed analyte specific reagent, the transformed analyte, or the transformed optically-active detection substance. Optical properties in which a change may be detected by the analyzer 190 include absorption properties, emission properties, diffraction properties, turbidimetric properties, and the like.

Optically-active detection substances in the reagent system 150 may include fluorescent dyes, which may be physically or chemically attached to the test chamber 110 and/or to one or more of the analyte specific reagents of the reagent system 150. The reagent system 150 may include one or more dyes that undergo a measurable change in response to the surrounding pH or surrounding oxygen concentration. The reagent system 150 may include one or more dyes that undergo a measurable change when the distance between two dyes change. The reagent system 150 may include one or more dyes that undergo a measurable change when the functional groups of surrounding moieties having the closest proximity to the dyes change. The reagent system 150 also may include one or more reference dyes that do not undergo a measurable change in response to the analysis. While the terms “fluorescent dye” or “dye” are generally used in this application to describe optically-active detection substances, it is to be understood that in addition to dyes, any species may be used that absorbs and/or emits at desirable wavelengths and is compatible with the test sensor 100 and the sample, including quantum dots, nanocrystals, reactive chemicals and the like. At present, fluorescent dyes are preferred as optically-active detection substances.

In one example, a reagent system 150 uses the glucose oxidase enzyme as the analyte specific reagent, in combination with pH and/or oxygen sensitive dyes as the detection substance. When exposed to glucose, the glucose oxidase enzyme reacts with glucose and oxygen (O₂) to produce gluconic acid (gluconolactone), thus lowering the oxygen content and the pH of the sample. pH sensitive dyes alter light in response to changes in pH, while oxygen sensitive dyes alter light in response to changes in oxygen concentration. As the decrease in sample oxygen content and/or pH is responsive to the glucose concentration of the sample, the change in the fluorescent signal or signals observed from the dye or dyes is responsive to the glucose concentration of the sample. In addition to the pH or oxygen sensitive dyes, an internal reference also may be provided by including one or more fluorescent dyes in the reagent system that are not pH or oxygen sensitive.

pH sensitive dyes that may be used with the test sensor 100 include those in Table I, below. When glucose is added to a mixture of glucose oxidase in PBS buffer, the pH of the mixture increases from 7.3 to 7.4. Preferably a pH sensitive dye for use in the test sensor is sensitive to pH changes within this range. Preferred pH sensitive dyes for use in the reagent system 150 of test sensor 100 include seminaphthorhodafluors (SNAFL), fluorescein isothiocyanate (FITC), and 8-hydroxypyrene-1,3,6-trisulfonic acid (HPTS). The HPTS dye is especially preferred as a pH sensitive dye that provides two fluorescence peaks, the ratio of which may be used to measure the change responsive to the analyte concentration. In this way, an internal standard may be provided to the optical analyzer without the need of a second dye.

TABLE I
pH Sensitive Fluorescent Dyes

| | pH | |
|---|---|---|
| Parent Fluorophore | Range | Typical Measurement |
| SNAFL | 6.0-8.2 | Excitation ratio 510/540 nm |
| SNARF indicators | 6.0-8.0 | Emission ratio 580/640 nm |
| FITC | 5.0-8.0 | Emission 520 nm |
| HPTS (pyranine) | 7.0-8.0 | Excitation ratio 450/405 nm |
| BCECF (2′,7′-Bis- | 6.5-7.5 | Excitation ratio 490/440 nm |
| (2-carboxyethyl)- | | |
| 5-(and-6)-carboxyfluorescein) | | |
| Fluoresceins and | 6.0-7.2 | Excitation ratio 490/450 nm |
| carboxyfluoresceins | | |

A dye used with the test sensor 100 may include an oxygen sensitive dye. Preferably an oxygen sensitive dye for use in the test sensor is an oxygen sensitive dye including bipyridyl (bpy) groups. Preferred oxygen sensitive dyes include (tris(2,2′-bipyridyl dichlororuthenium) hexahydrate (Ru(bpy)).

Binding reagent systems for use in the reagent system 150 of test sensor 100 rely on the association of an analyte with one or more components of the reagent system, and may use one or more optical analysis techniques to determine the separation and/or a change in the separation of two or more dyes. Binding reagent systems also may use optical techniques that determine a change in the electron density surrounding one or more dyes.

Examples of binding reagent systems include ligand-receptor systems in which the ligand and the receptor are each attached to different fluorescent dyes. This type of binding reagent system may produce an optically measurable change in the presence of an analyte due to fluorescence resonance energy transfer (FRET). Examples of donor and acceptor dyes that may be used in such a system are described, for example in U.S. Provisional Patent Application No. 61/287,485 entitled “Transdermal Systems, Devices, and Methods to Optically Analyze an Analyte,” with inventors Swetha Chinnayelka et al., filed Dec. 17, 2009.

Examples of binding reagent systems also include donor/quencher systems, in which an increase in the efficiency of the resonance energy transfer between the donor and the quencher provides for a decrease in the light output measured from the system. Thus, resonance energy transfer also may be measured using a fluorescent and a quenching dye as the donor and acceptor molecules, respectively. Any quenching dye may be used that adsorbs light from the donor and is compatible with the analysis. Examples of suitable quenching dyes include dabcyl chromophores and diarylrhodamine derivatives, such as those sold as QSY 7, QSY 9, and QSY 21 by Invitrogen, Carlsbad, Calif. Presently, the diarylrhodamine derivatives are preferred as quenching dyes. When a quenching dye is used, there will not be a substantial second fluorescent peak as a control, unless an additional control and/or reference dye is added to the analysis. Examples of donor and acceptor dyes that may be used in such a system are described, for example in U.S. Provisional Patent Application No. 61/287,485 entitled “Transdermal Systems, Devices, and Methods to Optically Analyze an Analyte,” with inventors Swetha Chinnayelka et al., filed Dec. 17, 2009.

The range of analyte concentrations that the test sensor 100 may detect optically in a sample may be increased in multiple ways. For reagent systems using enzymes, the detectable analyte concentration range may be increased by using one enzymatic reaction and different dyes to measure different pH ranges. For example, Table II, below, shows that green, orange, and red dyes may measure glucose concentrations in ISF in the range of 0-20 mM, 20-40 mM, and 40-60 mM, respectively. Thus, the green dye would alter light at higher pH values, while the red dye would alter light at lower pH values, reflecting lower and higher glucose concentrations, respectively.

TABLE II
Concentration Response of Fluorescent Dyes

| | Glucose concentration | | |
|---|---|---|---|
| | 0-20 mM | 20-40 mM | 40-60 mM |
| Fluorescent dye color | Green | Orange | Red |

The operating range of the test sensor 100 also may be increased by using a first enzyme specific to analyte sample concentrations in the micromolar range and a second enzyme specific to analyte sample concentrations in the millimolar range. In this system, analyte concentrations may be determined in both ranges if the first and second enzymes are associated with dyes that alter light differently. Similarly, the concentration of multiple analytes in a sample may be determined using different enzymes, each specific to a different analyte and each associated with a dye that alters light differently. For example, Table III below shows that a green dye is associated with the glucose oxidase enzyme and will absorb or emit light at different green wavelengths depending on the glucose concentration of the sample. By measuring the light alterations in the green, orange, and red wavelengths for the sample, the concentrations of glucose, lactate, and cholesterol may be determined individually.

TABLE III
Analyte Specificity of Combinations
of Enzyme and Fluorescent Dyes

| | Glucose | Lactate | Cholesterol |
|---|---|---|---|
| Enzyme | Glucose Oxidase | Lactate Oxidase | Cholesterol Oxidase |
| Fluorescent | Green | Orange | Red |
| dye color | | | |

A test sensor 100 that includes an optically-active detection substance in the reagent system 150 may be used to analyze a sample as soon as sufficient analyte reaches the liquid 140. Preferably, such a test sensor can be used to perform an analyte analysis within 2 hours, 50 minutes, 40 minutes, 30 minutes, 20 minutes or less of being adhered to the tissue. More preferably, such a test sensor can be used to perform the analyte analysis within 15 minutes or less of being adhered to the tissue. In contrast, conventional electrochemical transdermal systems in which the reagent is in a hydrogel typically require a long electrode conditioning period of more than one hour before analysis may be performed.

A test sensor 100 that includes an optically-active detection substance in the reagent system 150 may reduce the accuracy problems resulting from one or more interferants in the sample. Sample interferants in electrochemical systems are chemical, electrochemical, physiological or biological species that result in a positive or negative bias in the electrochemically determined analyte concentration. Compensation for inaccuracies due to sample interferants in conventional electrochemical test sensors typically requires a separate electrode or electrode system to quantify each interferant, which in turn requires additional processing by the measurement device to remove the contribution of the interferant from the measured analyte concentration. A test sensor 100 that includes an optically-active detection substance in the reagent system 150 can avoid these complications by using a reagent system 150 that is highly specific to the analyte.

The analyzer 190 is in communication with the liquid 140, and detects and/or quantifies the measurable species produced in response to the interaction of the reagent system 150 with the analyte. For an electrochemical analysis, the analyzer 190 may include one or more electrodes in electrochemical communication with the liquid 140. For an optical analysis, the analyzer 190 may include an electromagnetic radiation detector in optical communication with the liquid 140, and optionally may include an electromagnetic radiation source in optical communication with the liquid 140.

FIG. 6 represents a transdermal test sensor 600 configured for electrochemical analysis. Transdermal test sensor 600 includes a test chamber 610 including a housing 620, a semipermeable membrane 630, a liquid 640 and a reagent system 650 in contact with the liquid 640. The transdermal test sensor 600 further includes electrochemical analyzer 690 in communication with the liquid 640. The housing 620 includes an opening, and the semipermeable membrane 630 is connected to the housing and covers the opening. The housing 620 and the semipermeable membrane 630 in combination enclose the liquid 640. The electrochemical analyzer 690 includes a working electrode 692, a counter electrode 694, optionally at least one other electrode 696, and optionally one or more electrical conductors 698 capable of electrically connecting the electrodes with a measurement device.

The test chamber 610, housing 620, semipermeable membrane 630 and liquid 640 may be as described above for test sensor 100 in FIG. 1. The reagent system 650 may be any electrochemical reagent system, and the components of the reagent system 650 independently may be physically or chemically attached to the interior of the housing 620, located within the liquid 640, or physically or chemically attached to the semipermeable membrane 630. These configurations are represented in FIG. 6 by positions A, B and C, respectively.

The working electrode 692, the counter electrode 694, and the at least one other optional electrode 696 may be in physical contact with the liquid 640 through one or more openings in the housing 620. The electrodes may be in electrochemical contact with the liquid 640 through the housing 620, provided the housing 620 is electrochemically conductive at the region between the housing and the electrodes.

The electrodes 692, 694 and optionally 696 include an electrical conductor material, and optionally include a reagent layer. The working electrode 692 and counter electrode 694 may be separated by 1,000 micrometers or more. Electrode separation distances less than 1,000 micrometers also may be used. The pattern of the electrodes is not limited to those shown in the figure, instead being any pattern compatible with the test sensor. Reagent layers are formed when a reagent composition is applied to an electrical conductor material. Preferably, the electrodes are formed by a rectangular deposition of a reagent composition and/or a charge transfer system. The deposition may be made by screen printing, ink-jetting, micro-pipetting, pin-deposition, or other methods.

The reagent composition may include some or all of the components of the reagent system as described for reagent system 150 in FIG. 1, and in addition may include a binder. For example, the reagent layer forming the working electrode 692 may include an enzyme as an analyte specific reagent, a mediator as a detection substance, and a binder, while the reagent layer forming the counter electrode 694 may include a mediator and a binder. Analytes undergo electrochemical reaction at the working electrode, while the opposite electrochemical reaction occurs at the counter electrode to allow current flow between the electrodes. For example, if an analyte or a detection substance undergoes oxidation at the working electrode, reduction occurs at the counter electrode.

In addition to working and counter electrodes, electrochemical analyzer 690 optionally may include a reference electrode 696 that provides a non-variant reference potential to the system. While multiple reference electrode materials are known, a mixture of silver (Ag) and silver chloride (AgCl) is typical due to the insolubility of the metal and its corresponding salt in the aqueous environment of the sample. Since the ratio of Ag metal to Cl⁻ does not significantly change in the sample, the potential of the electrode does not significantly change. If increased in size and/or modified with a conductive metal, a reference electrode also may be used as a counter electrode because it will pass current. However, a counter electrode may not serve as a reference electrode because it lacks the ability to isolate the half cell that provides the reference potential from the sample solution.

The material or materials used to form the electrical conductor materials of electrodes 692, 694 and optionally 696 may include any electrical conductor. Preferable electrical conductors are non-ionizing, such that the material does not undergo a net oxidation or a net reduction during analysis of the sample. The conductors may be made from materials such as solid metals, metal pastes, conductive carbon, conductive carbon pastes, conductive polymers, and the like. The conductors preferably include a thin layer of a metal paste or metal, such as gold, silver, platinum, palladium, copper, or tungsten. A surface conductor may be deposited on all or a portion of the conductor. The surface conductor material preferably includes carbon, gold, platinum, palladium, or combinations thereof. If a surface conductor is not present on a conductor, the conductor is preferably made from a non-ionizing material.

The conductor and optional surface conductor material may be deposited by any means compatible with the operation of the test sensor, including foil deposition, chemical vapor deposition, slurry deposition, metallization, and the like. In another aspect, the conductors may be formed by processing a conductive layer into a pattern using a laser and/or mask techniques.

The reagent composition or compositions used to form the electrodes 692 and/or 694 may be deposited in solid, semi-solid, liquid, gel, gellular, colloidal, or other form and may include one or more reagent system components and optionally a binder. The reagent compositions may have viscosities ranging from about 1 centipoise (cp) to about 100 cp. More preferable reagent compositions have viscosities ranging from about 1 cp to about 20 cp, or from about 4 cp to about 10 cp. Reagent compositions with other viscosities may be used. Viscosities are determined with a Brookfield Model DV3 Viscometer equipped with an ULA assembly for measuring reagent compositions having viscosities lower than 300 cp, and are performed at room temperature with the instrument temperature set to 25° C., at shear rates of 50, 100, 200 and 300 cps (cycle per second) to provide an indication of whether the composition is sheared thin or thick, and using a 100 mM phosphate buffer solution as a control, which may gave viscosity readings in the range of about 1 to about 1.3 cp under different shear rates.

The binder is preferably a polymeric material that is at least partially water-soluble. The binder may form a gel or gel-like material when hydrated. Suitable partially water-soluble polymeric materials for use as the binder may include poly(ethylene oxide) (PEO), carboxy methyl cellulose (CMC), polyvinyl alcohol (PVA), hydroxyethyl cellulose (HEC), hydroxypropyl cellulose (HPC), methyl cellulose, ethyl cellulose, ethyl hydroxyethyl cellulose, carboxymethyl ethyl cellulose, polyvinyl pyrrolidone (PVP), polyamino acids such as polylysine, polystyrene sulfonate, gelatin and derivatives thereof, polyacrylic acid and derivatives and salts thereof, polymethacrylic acid and derivatives and salts thereof, starch and derivatives thereof, maleic anhydrides and salts thereof, and agarose based gels and derivatives thereof. The binder may include one or more of these materials in combination. Among the above binder materials, PEO, PVA, CMC, and HEC are preferred, with CMC being more preferred at present for biosensors. Other binders may be used.

The electrochemical analyzer 690 measures an electrical signal generated by the reaction of the reagent system 650 with the analyte. The analyte typically undergoes a redox reaction when an excitation signal is applied to a sample containing the analyte. The test excitation signal initiates a redox reaction of the analyte in a sample of biological fluid. The test excitation signal usually is an electrical signal, such as a current or potential, and may be constant, variable, or a combination thereof, such as when an AC signal is applied with a DC signal offset. The test excitation signal may be applied through electrodes 692 and/or 694 as a single pulse or in multiple pulses, sequences, or cycles. The redox reaction generates a test output signal in response to the excitation signal. The output signal usually is another electrical signal, such as a current or potential, which may be measured through electrodes 692 and/or 694 and correlated with the concentration of the analyte in the sample. The output signal may be measured constantly or periodically during transient and/or steady-state output. Various electrochemical processes may be used such as amperometry, coulometry, voltammetry, gated amperometry, gated voltammetry, and the like.

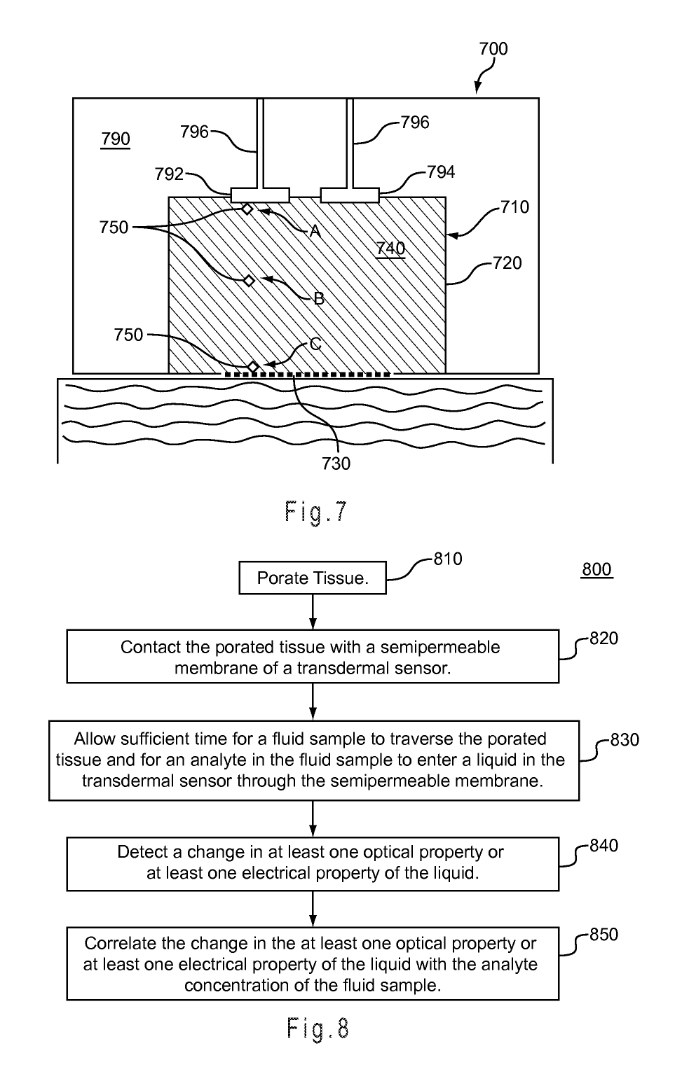

FIG. 7 represents a transdermal test sensor 700 configured for optical analysis. The transdermal test sensor 700 includes a test chamber 710 including a housing 720, a semipermeable membrane 730, a liquid 740 and a reagent system 750 in contact with the liquid 740. The transdermal test sensor 700 further includes an optical analyzer 790 in communication with the liquid 740. The housing 720 includes an opening, and the semipermeable membrane 730 is connected to the housing and covers the opening. The housing 720 and the semipermeable membrane 730 in combination enclose the liquid 740. The optical analyzer 790 is in communication with the liquid 740 and includes an electromagnetic radiation detector 792, optionally an electromagnetic radiation source 794, and optionally one or more electrical or optical connectors 796 capable of connecting the detector, and optionally the source, with a measurement device.

The test chamber 710, housing 720, semipermeable membrane 730 and liquid 740 may be as described above for test sensor 100 in FIG. 1. The reagent system 750 may be any optical reagent system, and the components of the reagent system 750 independently may be physically or chemically attached to the interior of the housing 720, located within the liquid 740, or physically or chemically attached to the semipermeable membrane 730. These configurations are represented in FIG. 7 by positions A, B and C, respectively.

The electromagnetic radiation detector 792 and the optional electromagnetic radiation source 794 may be in physical contact with the liquid 740, such as through one or more openings in the housing 720. A source 794 that is in physical contact with the liquid 740 may provide an increase in light energy applied to the dyes. Preferable sources for use within the test chamber 710 are organic light emitting diodes (OLEDs). The electromagnetic radiation detector 792 and/or the optional electromagnetic radiation source 794 may be in optical contact with the liquid 740 through the housing 720, provided the housing 720 is transparent to electromagnetic radiation at the region in contact with the source and/or detector. The electromagnetic radiation detector 792 and/or the optional electromagnetic radiation source 794 may be located at a remote location from the test chamber 710, and may be in optical communication with the liquid 740 by an optical fiber, light pipe, or the like.

The electromagnetic radiation detector 792, optional optical filters (not shown), and the electromagnetic radiation source 794 are known in the art, such as described in US 2002/0151772. Examples of preferable devices for use as the electromagnetic radiation detector 792 include those comprising silicone, silicon avalanche, GaAs photodiodes, and like devices capable of converting light into electricity. Examples of preferable devices for use as the electromagnetic radiation source 794 include light emitting diodes (LEDs), dual LEDs, laser diodes, broadband sources, specific bandwidth LEDs, and the like. For multiple dyes, a broadband source may be used with different optical filters, different wavelength LEDs may be used as the source 794, and the like.

The optical analyzer 790 measures the amount of light absorbed and/or generated by the reaction of the reagent system 750 with the analyte. After being altered by the reagent system, the light from the liquid 740 is preferably converted into an electrical signal, such as current or potential, by the detector 792.

In light-absorption optical analyses, the reagent system 750 produces a measurable species that absorbs light. An incident excitation beam from the electromagnetic radiation source 794 is directed toward the liquid 740. The incident beam may be reflected back from or transmitted through the sample to the electromagnetic radiation detector 792, depending on the placement of the detector 792. The detector 792 collects and measures the attenuated incident beam. The amount of light attenuated by the measurable species is an indication of the analyte concentration in the sample.

In light-generated optical analyses, the reagent system 750 produces a measurable species that fluoresces or emits light in response to the analyte. The detector 792 collects and measures the generated light. The amount of light produced by the measurable species is an indication of the analyte concentration in the sample.

FIG. 8 depicts a non-invasive method 800 of determining the presence and/or concentration of an analyte in a fluid sample with a transdermal test sensor. The method 800 may include determining the concentration of one or more analytes in the fluid sample continuously or intermittently.

In 810, a tissue is porated. Any poration technique may be used that provides the desired flow of analyte containing fluid to the test sensor. Examples of such techniques include ultrasonic processes, abrasion such as microneedle abrasion, laser ablation, and reverse iontophoresis.

In a preferred method, poration of tissue may be accomplished by ultrasonic processes, such as described in U.S. Patent Pub. Nos. 2004/0236268 and 2006/0094946. In this method, low-frequency ultrasonic waves increase the permeability of the tissue, presumably by disruption of the lipids in the stratum corneum, creating micropores. This transient disruption of the tissue has been shown to facilitate the non-invasive transdermal measurement of analytes without causing pain or significant adverse cutaneous effects (Kost, Nature Med., 6: 347-350 (2000)). Preferably, the device uses an ultrasonic horn with low frequency ultrasonic technology that, in addition to increasing permeability of the tissue, contains a microprocessor that automatically measures and records conductivity data. The microprocessor preferably performs on-line mathematical analysis of the conductivity and determines the best ultrasonic application duration to prevent unnecessary tissue irritation.

In another method, poration of tissue may be accomplished by microneedle abrasion, such as described in U.S. Pat. No. 6,835,184. In this method, a microabrader is positioned at a delivery site on the skin of a patient, where the microabrader has a support and a plurality of microneedles coupled to the support. Each of the microneedles has a length greater than the thickness of the stratum corneum, preferably from about 50 to 250 micrometers, and the microneedles may be arranged in an array of columns and rows and may be substantially uniformly spaced apart. The microabrader is moved across the tissue of the patient to allow the microneedles to penetrate into the stratum corneum substantially without piercing the stratum corneum. The movement of the microabrader across the skin abrades the stratum corneum at the delivery site to increase the permeability of the skin to ISF and/or an analyte in the ISF. The microabrader may be moved in a substantially straight line, and may be repositioned and moved across the skin one or more additional times.

In another method, poration of tissue may be accomplished by laser ablation, such as described in WO 2000/059371. In this method, an optical activation head is positioned on the surface of tissue, and optical energy such as laser radiation is applied to the surface of the tissue by the activation head. The applied optical energy heats the tissue and/or transfers heat by conduction to the tissue to ablate the tissue and form at least one opening in the tissue. Fluid such as ISF can then be collected from the tissue.

In another method, poration of tissue may be accomplished by reverse iontophoresis, such as described in U.S. Pat. No. 6,594,514. In this method, an iontophoretic sampling system, having one or more iontophoretic collection reservoirs in operative contact with an iontophoretic electrode, is placed in contact with tissue. The first iontophoretic electrode is operated as an iontophoretic cathode, the second iontophoretic electrode is operated as an iontophoretic anode, and substances such as ISF are actively extracted into the collection reservoir(s). The first iontophoretic electrode may then be operated as an anode, the second iontophoretic electrode may be operated as a cathode, and substances such as ISF again may be actively extracted into the collection reservoir(s). In addition, substances such as ISF that are passively extracted from the tissue are collected into another collection reservoir that is in contact with the tissue. Examples of passive collection reservoirs include skin patches and the like.

In 820, at least a portion of the porated tissue is contacted with the semipermeable membrane of a transdermal sensor, such as the test sensor 100, 600 or 700 as previously discussed with regard to FIG. 1, FIG. 6 and FIG. 7. The semipermeable membrane of the transdermal sensor may be held to the tissue with any adhesive or other method suitable for tissue use.

In 830, sufficient time is allowed for a fluid sample to traverse the tissue porated in 810 and for an analyte in the fluid sample to enter a liquid in the transdermal sensor through the semipermeable membrane. The semipermeable membrane may be as described for semipermeable membranes 130, 630 or 730 as previously discussed with regard to FIG. 1, FIG. 6 and FIG. 7. The liquid may be as described for liquids 140, 640 or 740 as previously discussed with regard to FIG. 1, FIG. 6 and FIG. 7.

In 840, a change in at least one optical property or at least one electrical property of the liquid is detected. Detecting a change in at least one optical property or at least one electrical property of the liquid may include applying a test excitation signal to the liquid and/or applying an excitation electromagnetic radiation beam to the liquid. A change in at least one optical property or at least one electrical property may include a change in the amount of a measurable species that is produced by the interaction of the analyte with a reagent system in the test sensor.

In 850, the change in the at least one optical property or at least one electrical property of the liquid is correlated with the analyte concentration of the fluid sample. One or more correlation equations relating changes detected with different concentrations of the analyte in samples may be obtained by analyzing multiple samples having known analyte concentrations. The relationship determined between the known analyte concentrations and their corresponding changes in optical and/or electrical properties of the liquid then may be used to determine experimental sample concentrations from changes detected from experimental samples.

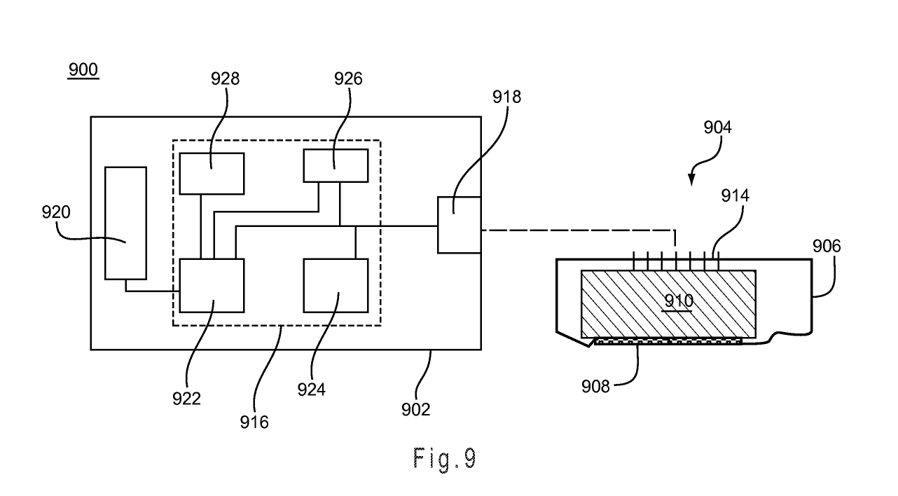

FIG. 9 depicts a schematic representation of a transdermal analysis system 900 that determines an analyte concentration in a sample of a biological fluid. Transdermal system 900 includes a measurement device 902 and a transdermal test sensor 904. Measuring device 902 and transdermal test sensor 904 may be adapted to implement an electrochemical analysis system, an optical analysis system, a combination thereof, or the like. The transdermal system 900 may be utilized to determine analyte concentrations, including those of glucose, lactate, cholesterol, glutamate, and the like. The transdermal system 900 may be used in clinical or home settings for detecting an analyte. While a particular configuration is shown, the transdermal system 900 may have other configurations, including those with additional components.

The transdermal test sensor 904 has a test chamber 906 and an analyzer 914. The test chamber 906 includes a liquid 910, a reagent system in contact with the liquid, and a semipermeable membrane 908. The reagent system may include one or more analyte selective reagents, such as enzymes, binding moieties, and like species. The reagent system may include one or more detection substances, such as dyes capable of interacting with electromagnetic radiation, electrochemical mediators, and like species. The semipermeable membrane 908 may be a semipermeable membrane as described above.

The analyzer 914 is in communication with the liquid 910. The test chamber 906 may have at least one portal or aperture for optical or electrochemical communication between the liquid 910 and the analyzer 914. An optical portal may be covered by an essentially transparent material. Optical portals may be located on opposite sides of the test chamber 906. An electrochemical portal may be covered by an electrochemically conductive material.

The analyzer 914 may be as described above for analyzers 190, 690 and/or 790. The analyzer 914 may be at least partially internal to the test chamber 906 when a detector, light source and/or electrodes of the analyzer are internal to the test chamber 906.

In light-absorption and light-generated optical systems, the analyzer 914 includes a detector that collects and measures light. The detector may receive light from the liquid 910 through an optical portal. The analyzer 914 optionally also includes a light source such as a laser, laser diode, a light emitting diode, or the like. The analyzer 914 may direct an incident beam from the light source through an optical portal. The detector may be positioned at an angle, such as 45° to the optical portal, to receive the light reflected back from the liquid 910. The detector may be positioned adjacent to an optical portal on the other side of the test chamber 906 from the light source to receive light transmitted through the liquid 910. The detector may be positioned in another location to receive reflected and/or transmitted light. The source and/or the detector may reside behind an optical screen or be embedded partially or wholly within the liquid 910. The detector may include silicone, silicon avalanche, GaAs photodiodes, and like devices capable of converting light into electricity.

In electrochemical systems, the analyzer 914 includes a working electrode and a counter electrode. The electrodes may communicate electrical signals with the liquid 910 through an electrochemical portal. The analyzer 914 also may include at least one other electrode, such as a reference electrode. The working and counter electrodes may be positioned adjacent to electrochemical portals on opposite sides of the test chamber 906, or the electrodes may be positioned on the same side of the test chamber.

The measurement device 902 includes electrical circuitry 916 connected to a sensor interface 918 and an optional display 920. The electrical circuitry 916 includes a processor 922 connected to a signal generator 924, an optional temperature sensor 926, and a storage medium 928. Measurement device 902 may have other components and configurations.

The sensor interface 918 has contacts that connect or electrically communicate with the analyzer 914 of the transdermal test sensor 904. Electrically communicate includes through wires, through optical fibers, wirelessly, and the like. Thus, the measurement device 902 may be incorporated with the transdermal test sensor 904, or the measurement device 902 and the transdermal test sensor 904 may be separate. The transdermal test sensor 904 may be in constant or in intermittent communication with the measurement device 902. The sensor interface 918 may be at least partially internal to the test chamber 906 when the analyzer 914 is at least partially internal to the test chamber 906.

The sensor interface 918 transmits input signals from the signal generator 924 to the analyzer 914. Sensor interface 918 transmits output signals from the analyzer 914 to the processor 922 and/or the signal generator 924. Sensor interface 918 may include a detector, a light source, and other components used in an optical sensor system.

The optional display 920 may be analog or digital. The display 920 may be a LCD, a LED, a vacuum fluorescent, or other display adapted to show a numerical reading. Other displays may be used. The display 920 electrically communicates with the processor 922. The display 920 may be separate from the measuring device 902, such as when in wireless communication with the processor 922. Alternatively, the display 920 may be removed from the measuring device 902, such as when the measuring device 902 electrically communicates with a remote computing device, medication dosing pump, and the like.

The processor 922 implements the analyte analysis and data treatment using computer readable software code and data stored in the storage medium 928. The processor 922 directs the signal generator 924 to provide the electrical input signal to the sensor interface 918. The processor 922 may receive the sample temperature from the temperature sensor 926. The processor 922 receives and measures output signals from the sensor interface 918, in response to the change in at least one optical property or at least one electrical property of the liquid 910.

The processor 922 determines one or more analyte concentrations from the output signals. Instructions regarding implementation of the analyte analysis may be provided by the computer readable software code stored in the storage medium 928. The code may be object code or any other code describing or controlling the functionality described herein. The data from the analyte analysis may be subjected to one or more data treatments, including the determination of decay rates, K constants, ratios, and the like in the processor 922. The results of the analyte analysis may be output to the optional display 920 and/or may be stored in the storage medium 928.

The signal generator 924 provides electrical input signals to the sensor interface 918 in response to the processor 922. Electrical input signals may include electrical signals used to operate or control a detector, light source and/or electrodes in the analyzer 914 and/or the sensor interface 918. Electrical input signals may be transmitted by the sensor interface 918 to the analyzer 914. Electrical input signals may be a potential or current and may be constant, variable, or a combination thereof, such as when an AC signal is applied with a DC signal offset. Electrical input signals may be applied as a single pulse or in multiple pulses, sequences, or cycles. Electrical input signals may include a test excitation signal used in an electrochemical sensor system. The signal generator 924 also may record an output signal from the sensor interface as a generator-recorder.

The optional temperature sensor 926 determines the temperature of the liquid 910 in the transdermal test sensor 904. The temperature of the liquid may be measured, calculated from the output signal, or assumed to be the same or similar to a measurement of the ambient temperature or the temperature of a device implementing the transdermal system. The temperature may be measured using a thermister, thermometer, or other temperature sensing device. Other techniques may be used to determine the liquid temperature.

The storage medium 928 may be a magnetic, optical, or semiconductor memory, another storage device, or the like. The storage medium 928 may be a fixed memory device, a removable memory device such as a memory card, a remotely accessed memory device, or the like.

In use, the transdermal test sensor 904 is disposed adjacent or remote to the measurement device 902. In either position, the analyzer 914 is in electrical and/or optical communication with the sensor interface 918. Electrical communication includes the transfer of input and/or output signals between contacts in the sensor interface 918 and electrical conductors and/or optical connectors in the analyzer 914. Optical communication includes the transfer of light between the analyzer 914 and a detector in the sensor interface 918. Optical communication includes the transfer of light between contacts in the sensor interface 918 and the analyzer 914.

The semipermeable membrane 908 of the transdermal test sensor 904 is placed in contact with porated tissue. A fluid sample for analysis is transferred into the liquid 910 through pores in tissue, such as skin. The fluid sample flows through the tissue and provides a pathway for the analyte to leave the tissue and enter the liquid 910 through the semipermeable membrane 908. The analyte reacts with the reagent system present in the test chamber 906 and/or the liquid 910 to produce a measurable species. The production of the measurable species in the liquid 910 provides a change in at least one optical property or at least one electrical property of the liquid, relative to the properties of the liquid in the absence of, or having a lower concentration of, the measurable species.

The processor 922 may start the analyte analysis in response to the presence of the transdermal test sensor 904 at the sensor interface 918, in response to user input, or the like. The processor 922 implements the analyte analysis using computer readable software code and data stored in the storage medium 928. The processor 922 directs the signal generator 924 to provide the electrical input signal to the sensor interface 918. The sensor interface 918 operates the analyzer 914 in response to the input signal.

The analyzer 914 detects a change in at least one optical property or at least one electrical property of the liquid 910, and communicates this change to the sample interface 918 as an output signal. An output signal may be an electrical signal such as current or potential, or it may be electromagnetic radiation. Output signals include a test output signal generated in response to a redox reaction of the analyte in the sample. Output signals include an attenuated light beam or an emitted light beam produced in response to the presence of a measurable species. Output signals may be generated using an optical system, an electrochemical system, or the like.

The processor 922 receives the output signal generated from the sample interface 918. The processor 922 also may receive the sample temperature from the temperature sensor 926.

The processor 922 determines one or more analyte concentrations from the output signals. The processor 922 may determine one or more analyte concentrations using one or more correlation equations. Correlation equations between analyte concentrations and output signals may be represented graphically, mathematically, a combination thereof, or the like. The correlation equations may be represented by a program number (PNA) table, another look-up table, or the like that is stored in the storage medium 928. The data from the analyte analysis may be subjected to one or more data treatments, including the determination of decay rates, K constants, ratios, and the like in the processor 922. The processor 922 may implement the data treatment using computer readable software code and data stored in the storage medium 928. The results of the analyte analysis may be output to the optional display 920 and/or may be stored in the storage medium 928.

The measurement performance of a biosensor system, such as a transdermal sensor system, typically is defined in terms of accuracy and/or precision. Accuracy may be expressed in terms of bias of the sensor system's analyte reading in comparison to a reference analyte reading, with larger bias values representing less accuracy. Precision may be expressed in terms of the spread or variance of the bias among multiple analyte readings in relation to a mean. Bias is the difference between one or more analyte concentration values determined from the biosensor system, and one or more accepted reference values for the analyte concentration in the biological fluid. Thus, one or more errors of a biosensor system in its analysis can result in a bias of the analyte concentration determined from the system. Bias may be expressed in terms of “absolute bias” in the units of the measurement such as mg/dL, or in terms of “percent bias” as a percentage of the absolute bias value over the reference value. Under the ISO standard for glucose measurements, absolute bias is used to express error in glucose concentrations less than 75 mg/dL, while percent bias is used to express error in glucose concentrations of 75 mg/dL and higher. Accepted reference values for analyte concentrations may be obtained with a reference instrument, such as the YSI 2300 STAT PLUS™ available from YSI Inc., Yellow Springs, Ohio.

Preferably a transdermal analysis system as described can detect glucose in ISF at least down to millimolar concentrations. By preferably configuring the various components, the system can achieve a precision between different assays of +5%, more preferably ±3%. At present, configurations providing a precision between different assays of ±0.5% are especially preferred.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A method for determining a concentration of at least one analyte in a fluid, comprising:
contacting porated tissue with a semipermeable membrane of a transdermal sensor,
allowing sufficient time for a fluid sample to traverse the porated tissue and for an analyte in the fluid sample to enter a liquid in the transdermal sensor through the semipermeable membrane,
detecting a change in at least one optical property or at least one electrical property of the liquid, and
correlating the change in the at least one optical property or at least one electrical property of the liquid with the concentration of the at least one analyte in the fluid sample.

18. The method of claim 17, where the liquid comprises water, and the amount of water in the liquid decreases by a first percentage when the semipermeable membrane is in contact with porated tissue for 12 hours;
where, when a comparable transdermal sensor, in which the liquid and semipermeable membrane are replaced with a hydrogel comprising water, is in contact with porated tissue for 12 hours, the amount of water in the hydrogel decreases by a second percentage, and
the second percentage is at least 5 times greater than the first percentage.

19. The method of claim 18, where the second percentage is at least 10 times greater than the first percentage.

20. The method of claim 17, where the at least one analyte comprises glucose, and the transdermal sensor has a first glucose sensitivity;
where, when the method is performed with a comparable transdermal sensor, in which the liquid and semipermeable membrane are replaced with a hydrogel, the comparable transdermal sensor has a second glucose sensitivity, and
the first glucose sensitivity is at least 20% greater than the second glucose sensitivity.

21. The method of claim 20, where the first glucose sensitivity is at least 30% greater than the second glucose sensitivity.

22. The method of claim 17, where the analyte is glucose, and the transdermal sensor has a first response time;
where, when the method is performed with a comparable transdermal sensor, in which the liquid and semipermeable membrane are replaced with a hydrogel, the comparable transdermal sensor has a second response time, and
the first response time is at least 50% shorter than the second response time.

23. The method of claim 17, where the analyte is glucose, and the transdermal sensor has a first time for producing 90% of a maximum response;
where, when the method is performed with a comparable transdermal sensor, in which the liquid and semipermeable membrane are replaced with a hydrogel, the comparable transdermal sensor has a second time for producing 90% of a maximum response, and
the first time is at least 2 minutes shorter than the second time.

24. The method of claim 17, where the liquid comprises a first amount of an enzyme, and the transdermal sensor has a first glucose sensitivity;
where, when the method is performed with a comparable transdermal sensor, in which the liquid and semipermeable membrane are replaced with a hydrogel comprising a second amount of the enzyme, and the comparable transdermal sensor has a second glucose sensitivity less than the first glucose sensitivity,
the first amount of the enzyme is at least 10 times less than the second amount of the enzyme.

25. The method of claim 17, where the liquid comprises a first amount of an enzyme, and the transdermal sensor has a first response time;
where, when the method is performed with a comparable transdermal sensor, in which the liquid and semipermeable membrane are replaced with a hydrogel comprising a second amount of the enzyme, and the comparable transdermal sensor has a second response time longer than the first response time,
the first amount of the enzyme is at least 10 times less than the second amount of the enzyme.

26. The method of claim 17, where the liquid comprises a first amount of an enzyme, and the transdermal sensor has a first time for producing 90% of a maximum response;
where, when the method is performed with a comparable transdermal sensor, in which the liquid and semipermeable membrane are replaced with a hydrogel comprising a second amount of the enzyme, and the comparable transdermal sensor has a second time for producing 90% of a maximum response longer than the first time for producing 90% of a maximum response,
the first amount of the enzyme is at least 10 times less than the second amount of the enzyme.

27. The method of claim 17, further comprising porating tissue.

28. The method of claim 17, where the detecting a change comprises applying a test excitation signal to the liquid.

29. The method of claim 17, where the detecting a change comprises applying an excitation electromagnetic radiation beam to the liquid.

30. The method of claim 17, further comprising outputting the value of the concentration of the at least one analyte to a display.

31. The method of claim 17, further comprising storing the value of the concentration of the at least one analyte in a storage medium.

32. A transdermal test sensor, comprising:
a test chamber comprising a liquid, a reagent system in contact with the liquid, a housing containing the liquid, and a semipermeable membrane,
where the housing comprises an opening,
the semipermeable membrane is connected to the housing and covers the opening,
the housing and the semipermeable membrane enclose the liquid and the reagent system, and
the semipermeable membrane comprises a hydrophilic surface and a maximum pore diameter of 10 to 50 nm; and
an analyzer in communication with the liquid.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. A transdermal analysis system, comprising:
means for contacting porated tissue with a semipermeable membrane of a transdermal sensor,
means for allowing a fluid sample to traverse the porated tissue and enter a liquid in the transdermal sensor through the semipermeable membrane,
means for detecting a change in at least one optical property or at least one electrical property of the liquid, and
means for correlating the change in the at least one optical property or at least one electrical property of the liquid with the concentration of the at least one analyte in the fluid sample.
